(19) United States
(12) Patent Application Publication
(10) Pub. No.: US 2011/0000791 A1
(43) Pub. Date: Jan. 6, 2011

(54) CAPILLARY DRIVEN ASSAY DEVICE AND ITS MANUFACTURE

(75) Inventors: Jonas Melin, Uppsala (SE); Christina Jonsson, Gnesta (SE)

Correspondence Address: Hiscock & Barclay, LLP, One Park Place, 300 South State Street, Syracuse, NY, 13202-2078, US

(73) Assignee: AMIC AB, Uppsala (SE)

(21) Appl. No.: 12/829,204

(22) Filed: Jul. 1, 2010

Related U.S. Application Data
(60) Provisional application No. 61/222,891, filed on Jul. 2, 2009.

(30) Foreign Application Priority Data
Jul. 2, 2009 (SE) 0950517-3

(51) Int. Cl. G01N 27/26; G01N 1/31

(52) U.S. Cl. 204/601; 427/2.13

(57) ABSTRACT

A method for the manufacture of a capillary driven assay device, includes the steps of: a) providing a capillary substrate, b) modifying the hydrophilicity of the surface of the substrate, c) mixing a matrix and a capturing molecule in a solution to obtain a solution comprising capturing molecules covalently bound to the matrix, and d) depositing the solution in a distinct area in the at least one retaining zone. A capillary driven assay device is obtainable by the method permitting the substrate to be modified with one surface chemistry and capturing molecules to be deposited in an optimal matrix on desired areas. Less matrix material is consumed, permitting several different matrix materials to be used on one chip.

### CROSS REFERENCE TO RELATED APPLICATIONS

This application is based upon U.S. Ser. No. 60/222,891, entitled NEW PROCESS AND DEVICE, filed Jul. 2, 2009 and Swedish Patent Application No. SE 0950517-3, filed Jul. 2, 2009, pursuant to relevant sections of 35 USC §119, the entire contents of each document herein being incorporated by reference.

### TECHNICAL FIELD OF THE INVENTION

The present invention relates to an improved method for surface hydrophilization and antibody immobilization on a cycloolefin-copolymer surface, in particular, in a capillary driven assay device.

### BACKGROUND OF THE INVENTION

The performance of biochemical reactions involving a solid phase is dependent on the chemical and physical properties of the surface of the solid phase. For immunoassays performed in capillary driven fluidic formats, the surface has to support liquid flow and provide a chemical handle for capture antibody immobilization. Moreover, to obtain a good assay performance, a high binding capacity of the analyte is desired.

Capillary driven microfluidic devices are described, for instance, in US 2005/042766, US 2006/0285996, US 2007/0266777, US 2008/0176272, US 2009/0208920, US 2009/0311805, US 2010/0009465, and US 2010/0041154, all to Åmic AB. In capillary driven microfluidic devices, it is often desirable to modify the properties of the surfaces which are intended to be in contact with a fluid. In many cases, it is desirable to modify the hydrophilicity of the surface so that an aqueous solution can flow easier through the capillary system. In particular, it is important to be able to control the forces between the surface of the microfluidic device and the fluid when the flow is capillary driven.

The surface of the microfluidic device can be modified in several ways. One way in the prior art of modifying the surface is to generate a more or less dense monolayer of a small organic molecule. This layer provides the necessary physical properties for the fluidics and acts as a handle for subsequent attachments of larger entities, such as matrix constituents and biomolecules. The preparation of such surfaces can be carried out in either gas phase or in liquid phase. The generation of surface enlarging matrices in the prior art involves molecules with high molecular weight, such as dextran or other polymeric materials. Such materials are therefore often attached to surfaces by means of liquid phase chemistry, e.g. dip coating. Affinity binders, such as antibodies or nucleic acids, are in some cases subsequently deposited on the matrix covered surface.

WO 90/01167 describes a porous support system for immobilization of immunoassay components.

RU 2 102 134 describes an immunosorbent with a carrier which may be aerosil that may be modified with a dextran solution and which is subsequently oxidized. The immunosorbent has improved specific capacity.

Jösson et al. in European Cells and Materials, Vol. 14, suppl. 3, 2007 (page 64) describes a silanized plastic surface functionalized with an oxidized dextran matrix. Capture antibodies are spotted on the functionalized surface. It is described that a high capacity matrix for antibody immobilization is provided. The capture antibody and the matrix (dextran) are not coupled to each other before they are spotted on the surface.

Jönsson et al. in Lab on a Chip, Vol. 8, 2008, pages 1191-1197 discloses a method for treatment of the surface of test chips. The surface is silanized by immersion in a solution of APTES (3-aminopropyl triethoxysilane). Oxidized dextran is subsequently coupled to amino groups of the surface. Subsequently, the surface with oxidized dextran coupled thereto is subjected to an oxidation step to generate reactive aldehydes for a reaction with amines in capture antibodies. Antibodies are coupled to the oxidized dextran after its immobilisation to the surface.

WO 03/020978 discloses a method for manufacturing a hydrogel biochip in which a matrix of a star-like polyethylene glycol derivative having an epoxy group at its terminal and a hydrophilic polymeric cross-linking agent are reacted with a probe or capture molecule to form a conjugate. The conjugate is subsequently deposited on the biochip.

US 2006/141484 discloses substrates comprising reactive ion etched surfaces and specific binding agents inunobilized thereon. Also disclosed are methods of making the reactive ion etched surfaces.

Jönsson C. et al. in European Cells and Materials vol. 14 2007, suppl. 3, page 64 discloses chips which are covered with APTES, coated with dextran, oxidized, and in which antibodies are spotted on the surface.

WO 2005/054860 discloses a method of detecting a biological marker in a sample.

Regarding capillary driven assays in the prior art in which surface modifications are necessary, it is also desirable to attach capture molecules taking part in a diagnostic assay. When the capture molecule is to be attached to the surface of a capillary driven fluidic device, limitations may be imposed regarding the modification of the surface properties, including the hydrophilicity. In some cases, modifications of the surface properties in capillary driven fluidic device are necessary in order for the capillary forces to be satisfactory. In the prior art, there is room for improvement in capillary driven fluidic devices where both attachment of capture molecules and modification of the surface hydrophilicity is desired.

### SUMMARY OF THE INVENTION

It is an object of the present invention to obviate at least some of the disadvantages in the prior art, and to provide an improved method and an improved capillary driven assay device. In particular, it is one object of the invention to provide a possibility to attach capture molecules to a capillary driven assay device where the possibility to modify the surface is improved.

There is in a first aspect, provided a method for the manufacture of a capillary driven assay device, in which the method comprises the steps:
a) providing a substrate, said substrate comprising at least one sample addition zone, at least one retaining zone, at least one sink, and at least one flow path connecting the at least one sample addition zone, the at least one retaining zone, and the at least one sink, wherein the at least one flow path is open and comprises projections substantially vertical to the surface of said substrate and having a height (H), diameter (D) and reciprocal spacing (t1, t2) such that lateral capillary flow of a liquid sample is achieved,
b) modifying the hydrophilicity of the surface of the substrate,
c) mixing a matrix and a capture molecule in a solution to obtain a solution comprising capture molecules covalently bound to the matrix, and
d) depositing the solution in a distinct area in the at least one retaining zone.

According to a second aspect, there is provided a capillary driven assay device comprising a substrate, provided on said substrate at least one sample addition zone, at least one retaining zone, at least one sink, and at least one flow path connecting the at least one sample addition zone, the at least one retaining zone and the at least one sink, wherein the at least one flow path is open and comprises projections substantially vertical to the surface of said substrate and having a height (H), diameter (D) and reciprocal spacing (t1, t2) such that lateral capillary flow of said sample is achieved, wherein the capillary driven assay device is manufactured by a method comprising the steps of:
a) modifying the hydrophilicity of the surface of the substrate,
b) mixing a matrix and a capture molecule in a solution to obtain a solution comprising capture molecules covalently bound to the matrix, and
c) depositing the solution in a distinct area in the at least one retaining zone.

Further aspects and embodiments are defined in the appended claims, which are specifically incorporated herein by reference.

Advantageously, it is possible to provide a surface modification in a capillary driven assay device and at the same time immobilize a capturing molecule in distinct and well defined areas on a substrate. There is provided more freedom to select a suitable surface treatment in order to modify the hydrophilicity of the surface in a capillary driven assay device. It is possible to modify the substrate with one surface chemistry and still deposit capturing molecules in an optimal matrix on desired areas.

Advantages further include that no liquid phase dip coating steps are necessary in order to attach the capturing molecule, which improves the reproducibility.

Furthermore, the matrix is only applied where the capturing molecule is deposited. Less matrix material is therefore consumed, as compared to coating the whole substrate. Since the matrix material only is deposited locally, different matrix formulations can be used for different affinity binders. In multiplex assays this approach offers the possibility to optimize the matrix formulation and reaction conditions for different capturing molecules by tailoring the e.g. binding capacity, density or thickness of the matrix. Furthermore, very small volumes of matrix material are required meaning that relatively high-cost matrices, such as multifunctional dendrons/dendrimers or rolling circle products, could potentially be used.

### BRIEF DESCRIPTION OF THE DRAWINGS

The invention is described in greater detail with reference to the drawings in which:

FIG. 1 shows a schematic figure of an assay device in which A is a sample addition zone, B is a retaining zone, and C is a sink, with the ability to receive liquid sample;

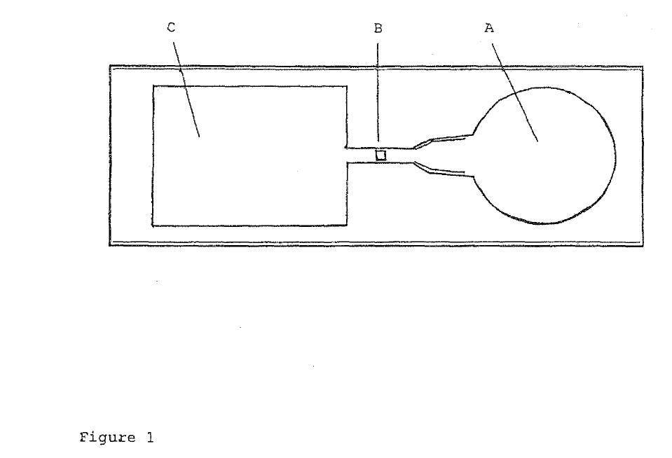

FIG. 2 shows a schematic picture of gas phase deposition followed by spotting of antibody covalently coupled to dextran matrix. In the top panel there is shown modification of the hydrophilicity of the surface of the substrate. In the middle there is shown deposition of dextran-antibody complex. In the bottom panel the deposited complex comprising dextran coupled to antibodies is shown. The matrix is only present where the antibody is deposited; and

FIG. 3 shows comparative dose responses for a CRP assay with dipcoated dextran and spotted dextran respectively.

### DETAILED DESCRIPTION OF THE INVENTION

### Definitions

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents, unless the context clearly dictates otherwise.

If nothing else is defined, any terms and scientific terminology used herein are intended to have the meanings commonly understood by those of skill in the art to which this invention pertains.

The term “about” as used in connection with a numerical value throughout the description and the claims denotes an interval of accuracy, familiar and acceptable to a person skilled in the art. Said interval is ±10%.

“Analyte” is used throughout the description and the claims to denote a substance or chemical or biological constituent of which one or more properties are determined in an analytical procedure. An analyte or a component itself can often not be measured, but a measurable property of the analyte can. For instance, it is possible to measure the concentration of an analyte.

“Assay device” is used throughout the description and the claims to denote a device which is used to analyze a sample. A diagnostic device is one example of an assay device.

“Capillary flow” as used throughout the claims and the description denotes flow induced mainly by capillary force.

“Capture molecule” is used throughout the description and the claims to denote a molecule with the ability to bind to another chemical or biological entity of interest. The term “capture molecule” includes molecules with the ability of specific binding to specific molecules.

“Casing” as used throughout the claims and the description denotes an element enclosing a part of or the entire device.

“Cycloolefin polymer” is used throughout the description and the claims to denote cyclic olefin copolymers based on different types of cyclic olefin monomers. Copolymers based on cyclic olefin monomers and ethane are encompassed within this term.

“Dendrimer” is used herein to denote repeatedly branched molecules and molecules. Dendrimers are monodisperse.

“Dendritic structure” is used herein to denote a branched structure. Examples of dendritic structures include but are not limited to dendrons, dendrimers, hyperbranched and dendronized polymers.

“Detectable group” as used throughout the claims and the description denotes any arrangement of molecules or atoms that can be detected when present on a substrate.

“Flow path” as used throughout the claims and the description denotes an area on the device where flow of liquid can occur between different zones.

“Fluid connection” as used throughout the claims and the description denotes a connection in which a fluid can be transported.

“Hydrophilicity” as used throughout the claims and the description in connection with a surface is related to the tendency of an aqueous solution to wet the surface. Wetting is the ability of a liquid to maintain contact with a solid surface, resulting from intermolecular interactions when the two are brought together. The degree of wetting is determined by a force balance between adhesive and cohesive forces. Wetting and the surface forces that control wetting are also responsible for other related effects, including capillary effects.

“Hyperbranched” as used throughout the claims and the description in connection with polymeric molecules denote a highly branched structure.

“Lid” as used throughout the claims and the description denotes an element covering a part of or the entire device.

“Matrix” is used throughout the description and the claims to denote a material to which capturing molecules are coupled.

“Open” as used throughout the claims and the description the term and used in connection with capillary flow means that the system is open; i.e., the system is not enclosed. Examples of an open system include a system without at lid in capillary contact with the sample liquid. In an open system a lid shall not be in capillary contact with the sample liquid; i.e., a lid shall not take part in creating the capillary force.

“Reciprocal spacing” as used throughout the claims and the description denotes the distance between adjacent projections.

“Retaining zone” is used throughout the description and the claims to denote an area on a capillary driven assay device where molecules in a sample can be bound to capturing molecules.

“Sample” as used throughout the claims and the description denotes a mixture or a solution to be analyzed.

“Sample addition zone” as used throughout the claims and the description denotes a zone where a sample is added.

“Silanize” is used throughout the description and the claims to denote the attachment of silane molecules on a surface.

“Sink” as used throughout the claims and the description denotes an area with the capacity of receiving liquid sample.

“Substance” as used throughout the claims and the description denotes any pure chemical or biological entity or any mixture or solution comprising at least one chemical or biological entity.

There is provided a method for the manufacture of a capillary driven assay device, the method comprising the steps:
a) providing a substrate, said substrate comprising at least one sample addition zone, at least one retaining zone, at least one sink, and at least one flow path connecting the at least one sample addition zone, the at least one retaining zone, and the at least one sink, wherein the at least one flow path is open and comprises projections substantially vertical to the surface of said substrate and having a height (H), diameter (D) and reciprocal spacing (t1, t2) such that lateral capillary flow of a liquid sample is achieved,
b) modifying the hydrophilicity of the surface of the substrate,
c) mixing a matrix and a capturing molecule in a solution to obtain a solution comprising capturing molecules covalently bound to the matrix, and
d) depositing the solution in a distinct area in the at least one retaining zone.

In one embodiment, the surface of the capillary driven assay device is oxidized prior to the depositing step. In one embodiment, the oxidation comprises plasma treatment. In one embodiment, the substrate surface is first activated by a gas phase plasma reaction and a small organic linker molecule is subsequently attached to the surface via gas phase deposition. Gas phase deposition is advantageous, since this makes production less complicated and improves reproducibility and homogeneity of the coating. The free end of the linker molecule presents a group (e.g. amine) reactive to or with affinity for the matrix. The binder-matrix complex can thus be spotted directly on the activated surface.

In one embodiment, at least a part of the surface of the capillary driven assay device is silanized. In one embodiment the silanization comprises silanization in gas phase.

In the modifying step b), the hydrophilicity of the surface of the substrate is modified, in which either the hydrophilicity is increased or is decreased. In one embodiment, the hydrophilicity is increased by adding polar groups on the surface. In another embodiment, the hydrophilicity is increased by adding charged groups on the surface.

In one embodiment, the entire surface of the substrate is modified with respect to the hydrophilicity of the surface. In an alternative embodiment, one side of the substrate is modified with respect to the hydrophilicity of the surface.

In one embodiment, the capillary driven assay device comprises at least one cycloolefin polymer surface.

In one embodiment, the matrix comprises a polysaccharide. In another embodiment, the matrix comprises agarose. In one embodiment, the matrix comprises dextran. In one embodiment, the matrix comprises oxidized dextran. In one embodiment, the matrix comprises a polyacrylamid gel. In one embodiment, the matrix comprises a hyperbranched polymer. In one embodiment, the matrix comprises a dendron. In one embodiment, the matrix comprises a dendrimer. In yet another embodiment, the matrix comprises a combination thereof.

In one embodiment, the capturing molecule comprises at least one entity selected from the group consisting of an antibody, an aptamer, a nucleic acid probe, a DNA probe, a RNA probe, a PNA probe, an antibody fragment, a Fab fragment, and a scFv fragment. In one embodiment, the capturing molecule is an antibody. According to another embodiment, the capturing molecule comprises a combination thereof.

There is further provided a capillary driven assay device comprising a substrate, wherein said substrate is provided thereon with at least one sample addition zone, at least one retaining zone, at least one sink, and at least one flow path connecting the at least one sample addition zone, the at least one retaining zone and the at least one sink, wherein the at least one flow path is open and comprises projections substantially vertical to the surface of said substrate and having a height (H), diameter (D) and reciprocal spacing (t1, t2) such that lateral capillary flow of said sample is achieved, wherein the capillary driven assay device is manufactured by a method comprising the steps of:
a) modifying the hydrophilicity of the surface of the substrate,
b) mixing a matrix and a capturing molecule in a solution to obtain a solution comprising capturing molecules covalently bound to the matrix, and
c) depositing the solution in a distinct area in the at least one retaining zone.

In one embodiment, the capillary driven assay device comprises at least two different matrices and at least two different capturing molecules, wherein each matrix is covalently bound to a specific type of capturing molecule.

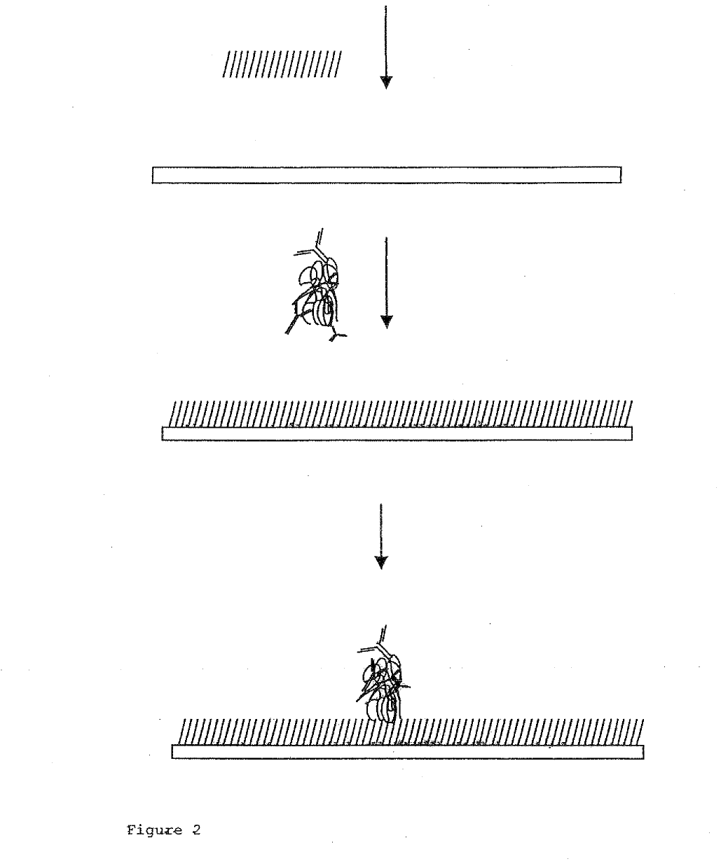

There is disclosed a way of generating a local three dimensional high capacity matrix in which only capturing molecules are deposited. This is achieved by conjugating the binder to a surface enlarging matrix in homogenous phase prior to deposition. The hydrophilicity of the substrate is modified and examples of surface modifications include, but are not limited to, adsoprbion of organic molecules, and reaction of chemical groups on the surface of the substrate. In FIG. 2, top panel, one embodiment is shown in which the hydrophilicity of the substrate is modified. FIG. 2, middle panel, depicts how capturing molecules are coupled to a matrix before being deposited on the surface. FIG. 2, bottom panel, shows how the complex comprising a matrix coupled to capturing molecules have been deposited on the substrate surface.

A polymeric material which is amorphous and shows the properties of high glass-transition temperature, Tg, optical clarity, low shrinkage, low moisture absorption, and low birefringence is suitable to use as a substrate for purposes herein. Cycloolefin polymers have bulky cyclic olefin units randomly or alternately attached to the polymer backbone and the polymer thus becomes amorphous and shows the desired properties. In one embodiment, the capillary driven assay device comprises at least one cycloolefin polymer surface. In one embodiment, the capillary driven assay device is made of a cycloolefin polymer. In one embodiment, the capillary driven assay device is injection molded in a cycloolefin polymer. In one embodiment, the cycloolefin polymer is manufactured by ring-opening metathesis polymerization of various cyclic monomers followed by hydrogenation.

In one embodiment, the analysis device comprises at least two different matrices and at least two different capturing molecules, wherein each matrix is covalently bound to a specific type of capturing molecule. In this way, it is possible to perform a multiplexed analysis with different capturing molecules where each type of capturing molecules has its own individually adapted matrix. Each pair of capturing molecule and matrix are mixed and subsequently spotted in a distinct predetermined area on the assay device.

Other features of the invention and their associated advantages will be evident to a person skilled in the art upon reading the description and the examples.

It is to be understood that this invention is not limited to the particular embodiments shown here. The following examples are provided for illustrative purposes and are not intended to limit the scope of the invention since the scope of the present invention is limited only by the appended claims and equivalents thereof.

### EXAMPLES

Plastic substrate chips made of Zeonor® (Zeon Corporation, Japan) were oxidized in oxygen plasma. The oxidation took place during 6 min in a plasma chamber (400 Plasma System) at a working pressure of 0.26 mbar, 1000 W and with a flow of oxygen at 100 ml/min.

Two different approaches for silanization were employed. Gas phase silanization was carried out in a Solitec BPM-2000 chamber with a batch size of three chips. In each deposition, 250 μl of APTES (Fluka) were applied on a watch glass placed on the hot plate (80° C.) in the chamber. Deposition was carried out for 15 minutes at a working pressure of 25 mmHg. As a result of the limited production capacity of the gas phase deposition chamber, a liquid phase deposition method was also used. In this protocol, the chips were immersed in a solution of 3 vol % APTES in 95% ethanol (Kemetyl, Sweden) for 2 hours. The chips were rigorously washed in ethanol and MilliQ-H₂O. For both approaches, the silane layer was cured over night at room temperature in air to allow for crosslinking of the silane resulting in a stable amine functionalized surface.

Oxidized dextran (Dextran T40 (40 kDa), Pharmacosmos, Denmark) was prepared by oxidizing in 30 mM NaIO₄ (Sigma Aldrich) and diluted to 2%. The capture antibody (αCRP, clone nr M701289, Fitzgerald, Mass.) was coupled to the oxidized dextran in aqueous solution. The solution contained 500 μg/ml antibody, 2% oxidized dextran, 1% trehalose (Sigma Aldrich) and 50 mM NaPO₄ (pH 7.5, Sigma Aldrich) buffer. The solution was incubated for one hour before deposition at the retaining zone on the chip surface. The solution was spotted in a line extending across the fluidic channel of the chip. The mixture was spotted under humid conditions (relative humidity of 75%) with a Nano-plotter NP 2.1 (Ge-Sim, Germany) across the fluidic channel, resulting in a ˜0.5×2 mm band. In total, the deposited volume was 16 nl. In control experiments, the entire chip was first immersed in oxidized 2% dextran solution for 2 hours and thoroughly rinsed in MilliQ-H₂O. Capture antibodies were deposited using the same protocol, replacing the dextran with MilliQ-H₂O.

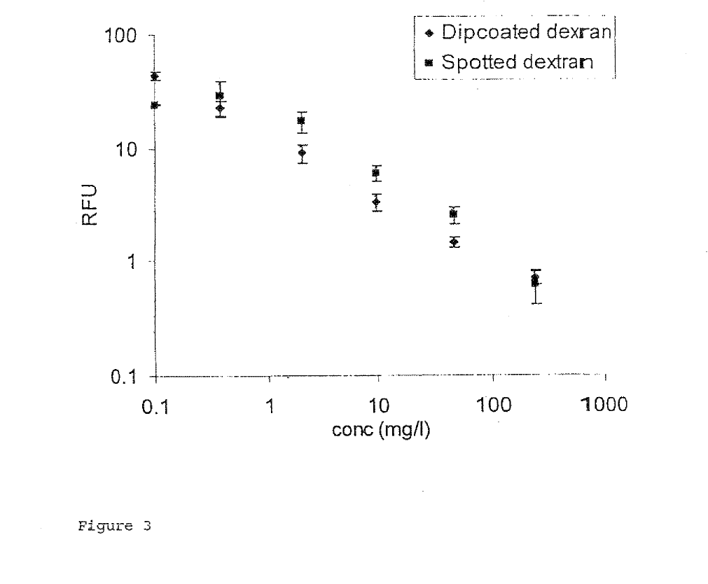

A competitive CRP assay was performed to characterize the performance of the method. CRP assay samples were prepared by diluting CRP in steps of five (250, 50, 10, 2, 0.4 and 0 mg/l) in CRP depleted serum (Scipack, UK). CRP was purchased from Scipac, UK. CRP was fluorescently labeled according to the supplier's instructions using Alexa Fluor® 647 Protein Labeling Kit (Invitrogen). Labeled CRP was added to the sample resulting in a final concentration of 1 mg/l. 37 μl. Sample was added to the sample zone of the chip and the capillary action of the micropillar array distributed the sample across the retaining zone into the wicking zone. The added volume is slightly greater than the total volume sustainable in the chip. No other liquid additions were needed before signal readout. A typical assay time was about 10 minutes. The signal intensities were recorded in a prototype line-illuminating fluorescence scanner. A new chip was used for each assay and all assays were performed in triplicate, unless stated otherwise. The results from an assay experiment, comparing spotted dextran and dip coated dextran, are shown in FIG. 3.

1. A method for the manufacture of a capillary driven assay device, the method comprising the steps of:
a) providing a substrate, said substrate comprising at least one sample addition zone, at least one retaining zone, at least one sink, and at least one flow path connecting the at least one sample addition zone, the at least one retaining zone, and the at least one sink, wherein the at least one flow path is open and comprises projections substantially vertical to the surface of said substrate and having a height (H), diameter (D) and reciprocal spacing (t1, t2) such that lateral capillary flow of a liquid sample is achieved,
b) modifying the hydrophilicity of the surface of the substrate,
c) mixing a matrix and a capturing molecule in a solution to obtain a solution comprising capturing molecules covalently bound to the matrix, and
d) depositing the solution in a distinct area in the at least one retaining zone.

2. The method according to claim 1, including the step of oxidizing the surface of the capillary driven assay device prior to said depositing step.

3. The method according to claim 2, wherein the oxidation step comprises plasma treatment.

4. The method according to claim 1, including the step of silanizing at least a part of the surface of the capillary driven assay device.

5. The method according to claim 4, wherein the silanizing step comprises silanization in gas phase.

6. The method according to claim 1, wherein the capillary driven assay device comprises at least one cycloolefin polymer surface.

7. The method according to claim 1, wherein the matrix comprises at least one of a polysaccharide and agarose.

8. The method according to claim 1, wherein the matrix comprises at least one of dextran and oxidized dextran.

9. The method according to claim 1, wherein the matrix comprises a polyacrylamid gel.

10. The method according to claim 1, wherein the matrix comprises a hyperbranched polymer.

11. The method according to claim 1, wherein the matrix comprises at least one of a dendron and a dendrimer.

12. The method according to claim 1, wherein the capturing molecule comprises at least one entity selected from the group consisting of an antibody, an aptamer, a nucleic acid probe, a DNA probe, a RNA probe, a PNA probe, an antibody fragment, a Fab fragment, and a scFv fragment.

13. The method according to claim 1, wherein the capturing molecule is an antibody.

14. A capillary driven assay device comprising a substrate and having provided on said substrate at least one sample addition zone, at least one retaining zone, at least one sink, and at least one flow path connecting the at least one sample addition zone, the at least one retaining zone and the at least one sink, wherein the at least one flow path is open and comprises projections substantially vertical to the surface of said substrate and having a height (H), diameter (D) and reciprocal spacing (t1, t2) such that lateral capillary flow of said sample is achieved, wherein the capillary driven assay device is manufactured by a method comprising the steps of:
a) modifying the hydrophilicity of the surface of the substrate,
b) mixing a matrix and a capturing molecule in a solution to obtain a solution comprising capturing molecules covalently bound to the matrix, and
c) depositing the solution in a distinct area in the at least one retaining zone.

15. The capillary driven assay device according to claim 14, including the step of oxidizing the surface of the capillary driven assay device prior to said depositing step.

16. The capillary driven assay device according to claim 15, wherein the oxidizing step comprises plasma treatment.

17. The capillary driven assay device according to claim 14, including the step of silanizing at least a part of the surface of the capillary driven assay device.

18. The capillary driven assay device according to claim 17, wherein the silanizing step comprises silanization in gas phase.

19. The capillary driven assay device according to claim 14, wherein the capillary driven assay device comprises at least one cycloolefin polymer surface.

20. The capillary driven assay device according to claim 14, wherein the matrix comprises at least one of a polysaccharide and agarose.

21. The capillary driven assay device according to claim 14, wherein the matrix comprises at least one of dextran and oxidixed dextran.

22. The capillary driven assay device according to claim 14, wherein the matrix comprises a polyacrylamid gel.

23. The capillary driven assay device according to claim 14, wherein the matrix comprises a hyperbranched polymer.

24. The capillary driven assay device according to claim 14, wherein the matrix comprises at least one of a dendron and a dendrimer.

25. The capillary driven assay device according to claim 14, wherein the capturing molecule comprises at least one entity selected from the group consisting of an antibody, an aptamer, a nucleic acid probe, a DNA probe, a RNA probe, a PNA probe, an antibody fragment, a Fab fragment, and a scFv fragment.

26. The capillary driven assay device according to claim 14, wherein the capturing molecule is an antibody.

27. The capillary driven assay device according to claim 14, comprising at least two different matrices and at least two different capturing molecules, wherein each matrix is covalently bound to a specific type of capturing molecule.
